(19) United States
(12) Patent Application Publication
(10) Pub. No.: US 2010/0198770 A1
(43) Pub. Date: Aug. 5, 2010

(54) IDENTIFYING PREVIOUSLY ANNOTATED WEB PAGE INFORMATION

(75) Inventors: Srinivasan H. Sengamedu, Bangalore (IN); Kalyan K. Kumar, Bangalore (IN); Charu Tiwari, Bangalore (IN)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo!, Inc., a Delaware corporation, Sunnyvale, CA (US)

(21) Appl. No.: 12/365,117

(22) Filed: Feb. 3, 2009

(51) Int. Cl. G06N 7/02

(52) U.S. Cl. 706/52

(57) ABSTRACT

Embodiments of methods, apparatuses, or systems relating to identifying previously annotated web page information are disclosed.

### CROSS-REFERENCE TO RELATED APPLICATIONS

This application is related to copending U.S. patent application Ser. No. ______, (Attorney Docket Number 070.P076) entitled “Updating Wrapper Annotations,” filed on ______.

### BACKGROUND

1. Field

The subject matter disclosed herein relates identifying previously annotated web page information.

2. Information

Web page information, particularly web page content, is continually being generated or otherwise identified, collected, or stored. While various ways exist to collect and/or store web page information, one common approach to do so utilizes a technique called wrapper induction. Generally speaking, wrapper induction may be capable of crawling and collecting web page information from an extensive number of web pages on a daily basis. This collected information may be used for a multiplicity of purposes, such as creating a more centralized database for web page information that would otherwise typically exist on a disparate plurality of web pages, as just one example.

With so much web page information being available, there is a continuing need for methods or systems that may allow for web page information to be collected and/or stored in an efficient manner.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a flow chart depicting an embodiment of a method to identify previously annotated web page information.

FIG. 2 is a schematic diagram illustrating two versions of the same web page in accordance with an embodiment.

FIG. 3 is a flow chart depicting an embodiment of a method to compare one or more extracted candidates of web page information with previously annotated web page information.

FIG. 4 is a schematic diagram depicting an embodiment of a system to identify previously annotated web page information.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment”, “an embodiment”, or “certain embodiments” may mean that a particular feature, structure, or characteristic described in connection with one or more particular embodiments may be included in at least one embodiment of claimed subject matter. Thus, appearances of the phrase “in one embodiment”, “an embodiment”, “certain embodiments”, or the like in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context. Therefore, the particular context of the description or the usage of these terms may provide helpful guidance regarding inferences to be drawn for that particular context.

Likewise, the terms, “and”, “and/or”, and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals, information, and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's memories, registers, and/or other information storage, transmission, and/or display devices.

As mentioned previously, there are numerous ways in which to extract information from web pages. One approach, for example, may utilize a technique called wrapper induction. Many variations of wrapper induction exist; in one example, wrapper induction may utilize or otherwise take advantage of annotations or tags in a markup language that delineate at least a portion of the web page information that may be extracted. For example, a human editor may create a wrapper that delineates certain information within an HTML, XML, and/or other like web page document/file to be extracted. By way of example but not limitation, a human editor may delineate a title, heading, and/or other like annotation or tag for a web page. The resulting wrapper may then be utilized to extract the corresponding information from the web page (and/or other like web pages).

To illustrate, for example, a particular web page may contain a title of a particular item for sale, such as a type of camera, and a sales price for that item. Human editors viewing this page may delineate (e.g., “annotate”) the title and sales price for the item on this particular web page for extraction by wrapper induction.

Typically, human editors annotate a relatively small number (e.g., few tens) of the web pages associated with a website, especially websites with a relatively large number of web pages that may exist and/or otherwise be generated. Such websites, for example, may employ a similar structure or format across the various web pages to provide continuity and ease of viewing for users interacting with the website. Thus, web pages on a retailer's website listing televisions for sale may provide title and price information in a similar location on a displayed web page as might another displayed web page that lists the title and price information for cameras. As such, wrapper induction may allow human editors to create one or more wrappers based on a small number of the pages on a particular website, which may then be utilized to extract information on a set of web pages associated with the website.

One technique that may improve wrapper induction in certain implementations is known as clustering. Here, web pages that may have a similar structure may be identified and clustered, or grouped, so that a template wrapper, or a more generic wrapper “trained” on a set or subset of web pages in a cluster, may be utilized to extract information from web pages throughout that cluster. Wrapper induction augmented with such a clustering technique may be used to extract web page information across a multiplicity of web pages. Such a clustering technique may be achieved via an automated process.

As illustrated in the examples presented above, wrapper induction often relies on human editors to identify or annotate information of a particular web page, which may introduce significant cost. Moreover, the use of human editors may introduce additional delays and may not be particularly effective where the information of a particular web page changes; even, in some instances, where the changes may be characterized as relatively minor. For example, websites may change the structure of a web page, such as by altering the location of the title of an item, or its sale price, on the web page. In this instance, for example, wrapper induction may not extract the desired information correctly. Thus, a human editor may need to re-annotate a particular web page if a wrapper does not extract the desired information.

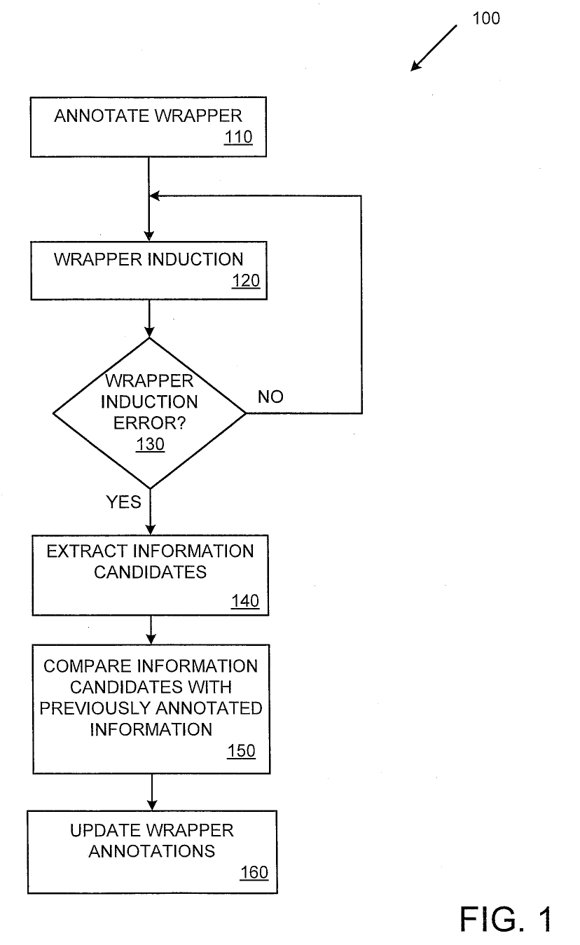

With this and other concerns in mind, in accordance with certain aspects of the present description, example implementations may include methods, systems, or apparatuses for identifying previously annotated web page information in a more efficient manner. FIG. 1, for example, is a flow chart depicting embodiment 100 of a method to identify previously annotated web page information. At block 110, a wrapper may be annotated for a set of web pages. Here, for example, human editors may annotate some percentage of web pages in a set of web pages for wrapper induction. In this example embodiment, the phrase “set of web pages” refers to a plurality of web pages clustered for wrapper induction. As one example, a cluster may comprise some or all web pages on a particular website, grouped together for wrapper induction purposes. Thus, a particular website may be clustered into one or more clusters, typically with each cluster having a particular wrapper. In other embodiments, however, a “set of web pages” may refer to a single web page, a plurality of web pages from a single or multiple websites, or a plurality of web pages from multiple clusters from a single or multiple websites, as non-limiting examples.

At block 120, an annotated wrapper may be used to perform wrapper induction that extracts information from a set of web pages. For example, web pages in a set of web pages may be processed (e.g., crawled, etc.) to extract information based at least in part on the annotated wrapper. Here, for example, extracted web page information may be stored in one or more databases or the like, such as may be provided in one or more servers.

At block 130, it may be determined (e.g., using an automated process) if there may be errors in the extracted webpage information as a result of a wrapper induction process. Here, for example, extracted web page information may be examined to determine if a wrapper induction process extracted information correctly (e.g., based on extraction records, etc.), or did not extract information at all. For example, in certain embodiments, an automated process may include a script using regular expressions. For example, if price is the wrapper extracted information, a script may determine whether the wrapper extracted information contains a currency symbol (e.g., $) as an example. If not, it may be determined that this information may not have extracted correctly, or at all.

As mentioned previously, a wrapper may not correctly extract information if, for example, a particular web page, or a set of web pages, undergoes a change, particularly a structural or format change. Alternatively or additionally, at block 130 in certain embodiments, an automated process may be employed to detect potential changes in a set of web pages, such as format or structural changes, prior to wrapper induction.

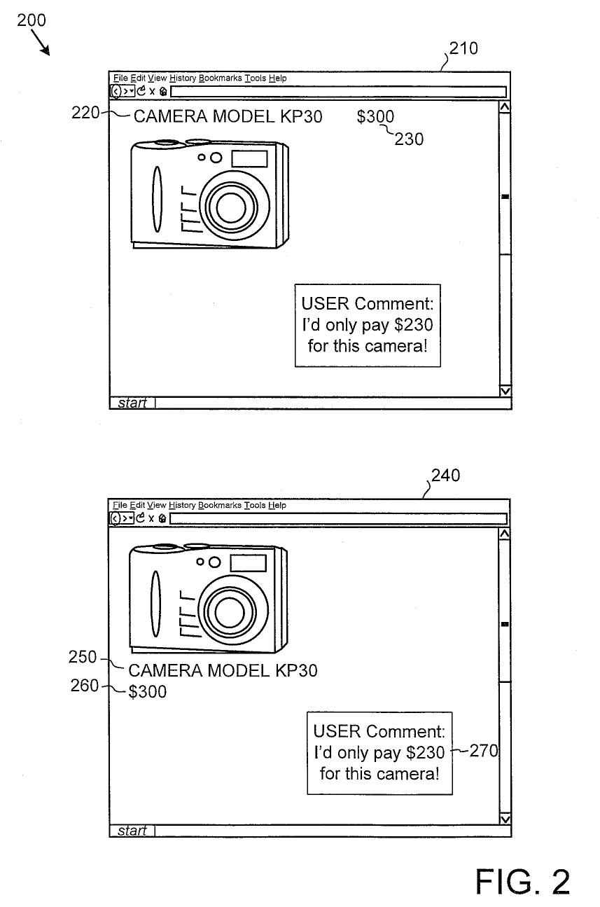

FIG. 2 may serve as a helpful reference to illustrate some of the concepts mentioned previously. For example, embodiment 200 in FIG. 2 depicts two versions of the same displayed web page. Here, displayed web page 210 lists a particular type of camera for sale. Title 220 and price 230 of the particular camera are listed on displayed web page 210. Displayed web page 240, in contrast, depicts a subsequent version of displayed web page 210 having a different structure. For example, title 250 and price 260 in displayed web page 240 are located in a different position compared to title 220 and price 230 on displayed web page 21 0.

Continuing with the illustration, assume title 220 and price 230 in displayed web page 210 were previously extracted via wrapper induction, such as may be performed at block 120 in FIG. 1. Thus, in this illustration, title 220 and price 230 in displayed web page 210 were previously annotated for wrapper induction. In this illustration, assume, however that a wrapper induction process did not extract title 250 and price 260 on newer displayed web page 240. That is, the wrapper did not extract information previously annotated on displayed web page 210 from newer or subsequent displayed web page 240. One reason a wrapper may not extract information correctly, or at all, may be that the content delineated by an annotation or tag (e.g., title 220 and price 230 in web page document/file associated with displayed web page 210) may no longer be associated with the same content (e.g., title 250 and price 260 in web page document/file associated with displayed web page 240) after a change, as just one example.

Returning to FIG. 1, and continuing with an illustrative embodiment, if a wrapper induction error is determined (“YES”) at block 130, then at block 140 a automated candidate extraction process may be utilized to extract web page information that may have extracted incorrectly via wrapper induction performed at block 120. A variety of techniques exist to perform extraction of web page information at block 140. While claimed subject matter is not to be limited to a particular technique, one automated candidate extraction process that may be utilized at block 140, for example, is described in related, copending U.S. patent application Ser. No. ______, (Attorney Docket Number 070.P076) entitled “Updating Wrapper Annotations,” filed on ______. A simplified recitation of this technique is described below.

In this particular technique, one way to extract web page information, which may not have extracted via wrapper induction, may be to utilize a site-specific Conditional Random Field (CRF) process. By way of example, a CRF process may include a stochastic sequential process that may be capable of identifying features in a web page which may indicate desired information to be extracted. Features, for example, may include such information as a currency symbol, a telephone number, or bolded text or larger font, as non-limiting examples. Thus, a CRF process may be capable of identifying features on a particular web page which may be useful to identify information to extract.

In certain example implementations, a site-specific CRF process may be employed and which may differ in various respects from a non-site-specific CRF process. For example, one respect in which a site-specific CRF process may differ from a non-site-specific CRF process may be that a site-specific CRF process may be trained to more specifically identify web page information for web pages associated with a particular website. Accordingly, in this regard, a site-specific CRF process may tend to have improved precision and recall for web pages on a particular website as opposed to a CRF process that may not have been trained on that particular website.

Training a site-specific CRF process, for example, may include training it, at least in part, on information from a particular website. Training on a particular website, for example, may allow a site-specific CRF process to more specifically identify web page information for web pages associated with a particular website. In addition, a site-specific CRF process may also be trained based, at least in part, on wrapper annotations for a set of web pages. For example, training information used to train a site-specific CRF process may include wrapper annotations for a set of web pages on a particular website, such as one or more wrapper annotations generated via block 110 in FIG. 1.

To illustrate, for example, reference is again made to FIG. 2. Displayed web page 240 depicts price 260. Assume, as above, that a wrapper did not extract price 260 from displayed web page 240. A site-specific CRF process may be trained so that it may determine that price is typically a number juxtaposed with a currency symbol. Accordingly, in this instance, one or more features that a site-specific CRF process may be indentifying may be a currency symbol and/or a number, as non-limiting examples. Thus, a site-specific CRF process, based at least in part on its training, may determine that a number and currency symbol are juxtaposed somewhere on displayed web page 240, such as at price 260, in a manner suggesting that the number and/or currency symbol may be a price. Accordingly, in this illustration, a site-specific CRF process may extract price 260.

Of course, in another embodiment, one or more other processes may be used at block 140 to extract web page information. For example, a non-site specific CRF process, Hidden Markov Models (HMM), Support Vector Machine (SVM) or other machine-learning models or techniques, may be used, as non-limiting examples.

Thus, returning to FIG. 1, in certain example embodiments, block 140 may include an automated candidate extraction process (e.g., a site-specific CRF process) processing (e.g., crawling, etc.) a set of web pages where a wrapper induction error may have occurred to extract information. An automated candidate extraction process may extract and store web page information in a database or the like, such as may be provided by one or more servers.

At block 130, if no wrapper induction error is determined (“NO”) then wrapper induction may continue to extract web page information via an induction process at block 120, as applicable.

In an embodiment, an automated candidate extraction process may extract a plurality of information candidates, which, for example, may be similar/dissimilar to previously annotated information. For example, in FIG. 2, displayed web page 240 depicts price 260 and price 270. As mentioned above, while price 260 may have been recognized and successfully extracted by an earlier wrapper induction process, other instances or variations of a price on displayed web page 240, such as price 270, may be recognized by an automated candidate extraction process and extracted. Thus, an automated candidate extraction process may be enabled to identify and extract multiple candidates of web page information from a particular web page. Accordingly, in this context, the term “candidate” is intended to mean information that was extracted via an automated candidate extraction process, such as information extracted at block 140 in FIG. 1. Thus, in an embodiment, candidate information may comprise particular web page information that an automated candidate extraction process extracted due, at least in part, to an error relating to the wrapper induction process to extract that particular web page information. Accordingly, an automated candidate extraction process may be enabled to extract certain information from a web page, such as extracting information that may correspond to previously annotated information, as an example.

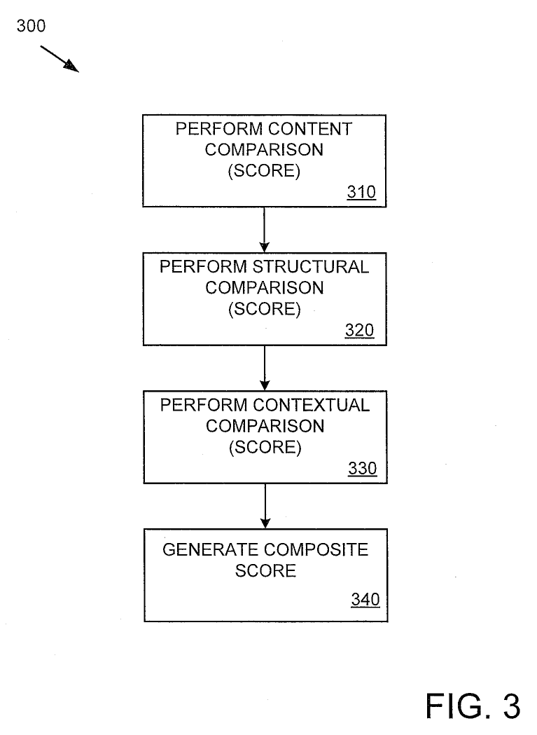

At block 150, extracted web page information candidates, such as information extracted via an automated candidate extraction process at block 140, may be compared with previously annotated information to identify if one or more of the information candidates corresponds to previously annotated information. There are a variety of ways to perform such a comparison. By way of example but not limitation, attention is drawn next to FIG. 3, which depicts an embodiment 300 of a method that may be implemented to compare one or more candidates of web page information with previously annotated web page information. This example embodiment may implement one or more comparison processes such as a content comparison process, a structural comparison process, a context comparison process, and/or any combination thereof.

In embodiment 300, for example, at block 310, a content comparison process may include comparing candidates with previously annotated information using a string comparison. To illustrate, referring again to FIG. 2, title 220 in displayed web page 210 may represent previously annotated information, such as information extracted via wrapper induction at block 120 in FIG. 1. Likewise, title 250 in displayed web page 240 may represent a candidate extracted from one or more web page documents/files associated with displayed web page 240, such as information extracted via an automated candidate extraction process at block 140. Accordingly, in this embodiment, both title 220 and title 250 may be stored in a database or the like. In this illustration, a content comparison process may include comparing textual and/or numeric content of title 220 with textual and/or numeric content of title 250 to identify substantially similar/dissimilar content; in other words, a content comparison process at block 310 may compare similar occurrences of a previously extracted alphanumeric string or other like information in the candidate information.

While there are many ways to perform textual or numeric comparison, one way may comprise employing fuzzy string matching technique, such as using Levenshtein Distance, for example. Of course, content comparison using a fuzzy matching technique is only one example of an approach that may be implemented to compare content; accordingly, claimed subject matter is not to be limited to any particular approach.

In certain example embodiments, one or more content comparison techniques at block 310 may score candidates to determine their similarity/dissimilarity with previously annotated information. Candidates that may better correspond to previously annotated information may score better (e.g., have a higher correspondence score) than candidates that may not match as well.

In certain example embodiments, at block 320, a structural comparison process may be implemented that is enabled to compare structural information from previously annotated information with structural information from candidate information. While types of structural information compared may vary by embodiment, one example of structural information that may be compared may comparing the respective locations of candidate information in the unrendered web page code with the location of previously annotated information. For example, a query language, such as an XML Path Language, may be utilized to identify Xpaths for previously annotated information and Xpaths for extracted candidate information, which may then be compared.

To illustrate, a comparison of Xpaths may include determining a distance in Xpaths of one or more candidates with an Xpath of previously annotated information. Xpath distances may be compared for simialriy and/or disimialirity. For example, Xpaths may comprise segments which may be separated by “/”. In certain embodiments, an Xpath distance may be determined by adding segment distances of each overlapping segment. The difference between position (e.g., indexes from the beginning) of each overlapping segment may be a segment distance. To illustrate, assume an Xpath of previously annotated information is the following: “/html/body/div/table/tr/td/span/h1”. Assume also that Xpaths for two extracted candidates are the following: “/html/body/div[@id=“new”]/div/table/tr/td/span/h1” (Candidate 1); and “/html/body/table/tr/td/div/p/h1” (Candidate 2). In this illustration, Candidate 1 may be determined to be a better candidate based on Xpath since it appears to contain more overlapping segments. Additionally and/or alternatively, Candidate 1 may be determined to be a better candidate based on Xpath since it may have similar total segment distances.

In certain embodiments, for example, candidates with respectively shorter distances may better correspond to the previously annotated information while candidates with respectively longer distances may not. Of course, structural comparison using Xpaths is only one example of an approach that may be implemented to compare structure; accordingly, claimed subject matter is not to be limited to any particular approach. Xpaths, for example, is merely one approach to identify nodes in a tree-like structure, such as a web page, and accordingly, other approach may exist or may be devised which may be encompassed by claimed subject matter.

In certain example embodiments, structural comparison processes, such as comparing Xpaths, may be enabled to score candidates as a measure of similarity/dissimilarity with previously annotated information. Candidates that may better correspond to previously annotated information may score better (e.g., have a higher correspondence score) than candidates that may not match as well.

In certain example embodiments, at block 330 a context comparison process may be implemented. Here, for example, a context comparison process may be enabled to compare contextual or associated information from previously annotated information with contextual or associated information relating to candidate information. While types of contextual or associated information may vary considerably from web page to web page, this type of information may include, for example, color information, symbol information, punctuation information, bolding information, italic information, underlining information, and/or the like. To illustrate, for example, in an embodiment, previously annotated information, such as a title or heading, may be of a certain color, font size and may be underlined. Thus, for example, a context comparison process at block 330 may include comparing such contextual or associated information of previously annotated information with contextual or associated information relating to one or more candidates. In certain embodiments, contextual comparison may also include comparing constant text that may be within or proximate to a particular node. For example, constant text may include “Price:” proximate to price information, “Address” proximate to address information, or “Alt” proximate to “click here to view information”, etc.

In certain example embodiments, a context comparison process may score candidates to determine their similarity/dissimilarity with previously annotated information. Candidates with similar contextual or associated information may, for example, score better (e.g., have a higher correspondence score) than candidates with at least some dissimilar contextual or associated information.

At block 340 in embodiment 300, a process may be implemented to generate a composite correspondence score which may be based, at least in part, on one or more correspondence scores generated by one or more comparison processes. Here, for example, a composite correspondence score for a particular candidate may include a score that is a function of one or more scores from one or more processes in blocks 310, 320, and/or 330. Of course, there are innumerable ways to generate a composite score and claimed subject matter is not to be limited to a particular approach. Thus, for example, a composite score may be a function of one or more scores, or it may place more emphasis on a particular comparison approach or account for them equally, as just a few examples. Alternatively, in an embodiment, a single score, such as a score from process 310, 320 or 330, may be utilized to identify a particular candidate as corresponding to previously annotated information.

In certain example embodiments, one or more correspondence scores determined by using one or more of the above approaches may be utilized to determine which candidate(s) may correspond to previously annotated information. For example, a particular candidate with a respectively better correspondence score (e.g., a candidate with the highest correspondence score out of a set of one or more scored candidates) may be identified as the candidate corresponding to previously annotated information.

Returning to FIG. 1, if a comparison process at block 150 has identified a particular corresponding candidate, such as by utilizing one or more of the comparison techniques mentioned previously, then at block 160 annotations for that particular previously annotated information may be transferred to or otherwise used to update one or more wrapper annotations. For example, annotations for particular previously annotated information may be transferred to a corresponding candidate. Accordingly, an automated process may transfer wrapper annotations from a prior version of a web page to corresponding candidate information in a subsequent version of that web page such that a wrapper may then be capable of extracting corresponding web page information from the subsequent version of that web page via wrapper induction.

In certain embodiments, if a comparison process at block 150 does not identify a particular corresponding candidate, then an automated candidate extraction process 140 may be retrained and/or may reprocess (e.g., re-crawl) a particular set of web pages to extract one or more candidates.

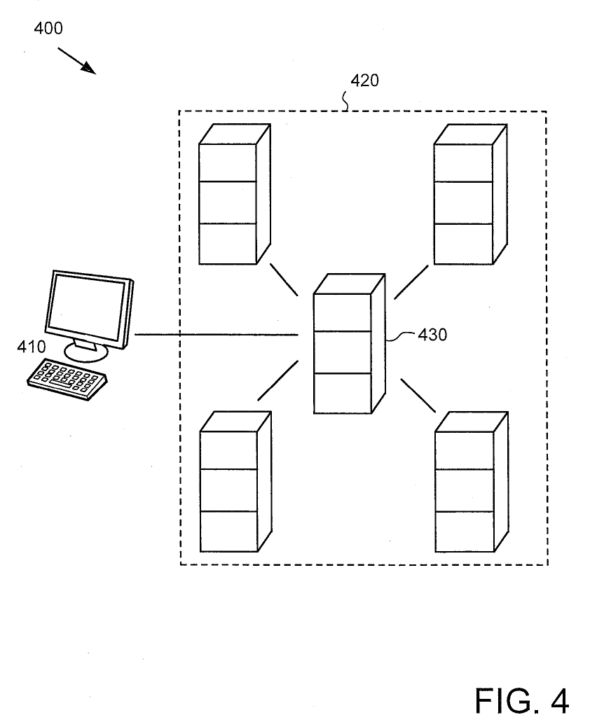

FIG. 4. is a schematic diagram depicting embodiment 400 of a system to identify previously annotated web page information. Embodiment 400 depicts a computing platform 410 communicatively coupled to a network of computing platforms 420. Similarly, computing platform 430 is depicted as being communicatively coupled to network 420. In this embodiment, network 420 may include a network of servers, such as an intranet of servers. In addition, in this embodiment, network 420 may be communicatively coupled the World Wide Web and/or the Internet (not depicted), and/or other like networks.

In certain embodiments, for example, computing platform 430 may include a special purpose computing platform. For example, in an embodiment, computing platform 430 may be capable of performing a wrapper induction process, such as previously described. Accordingly, in an embodiment, computing platform 430 may communicate via a communication protocol with one or more other computing platforms, such as communicating via an HTTP compatible or HTTP compliant standard with networked Internet computing platforms, for example. Thus, computing platform 430 may be capable of crawling one or more web pages which may be stored on other networked computing platforms to extract web page information. Here, computing platform 430 may store extracted web page content.

In addition, in an embodiment, computing platform 430 may be capable of determining if a wrapper induction error occurred, such as previously described. Here, computing platform 430 may have stored a program executing to review extraction records and determine if a wrapper extracted information correctly/incorrectly, or did not extract information at all, as just an example.

In addition, in an embodiment, computing platform 430 may be capable of performing candidate extraction processes, comparison processes, and wrapper annotation update processes. Thus, computing platform 430 may have stored there on one or more programs capable of performing one or more of these operations, such as previously described.

Of course, in another embodiment, computing platforms other than computing platform 430 may be capable of performing one or more of the various processes mentioned previously. For example, one or more of the networked computing platform in network 420 may perform some part, or all, of one or more of the processes previously described. In addition, one or more computing platform in network 420 may also store web page information.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method, comprising:
identifying one or more web page information candidates corresponding to previously annotated information using an automated candidate extraction process;
wherein said identifying comprises comparing said one or more web page information candidates, at least in part, with said previously annotated information, at least in part.

2. The method of claim 1, where said comparing said one or more web page information candidates, at least in part, with said previously annotated information, at least in part, comprising using at least one of the following comparison approaches: content comparison, structural comparison, context comparison, or a combination thereof.

3. The method of claim 1, wherein said automated candidate extraction process comprises a Site-Specific Conditional Random Field process.

4. The method of claim 1, wherein, prior to said identifying, extracting said previously annotated information.

5. The method of claim 4, wherein said extracting previously annotated information comprises extracting via a wrapper induction process.

6. The method of claim 1, wherein, prior to said identifying, extracting said one or more web page information candidates.

7. The method of claim 6, wherein said extracting said one or more web page information candidates comprises extracting via an automated candidate extraction process.

8. The method of claim 1, wherein said comparing said one or more web page information candidates, at least in part, with said previously annotated information, at least in part, further comprises generating at least one correspondence score.

9. The method of claim 8, wherein said generating at least one correspondence score comprises generating a composite correspondence score.

10. An apparatus, comprising:
a special purpose computing platform; said computing platform further comprising a storage medium having instructions stored thereon; said storage medium, if said instructions are executed, further instructing said computing platform to compare one or more web page information candidates extracted via an automated candidate extraction process, at least in part, with previously annotated web page information, at least in part, to identify an information candidate corresponding to said previously annotated web page information.

11. The apparatus of claim 10, wherein said compare one or more web page information candidates extracted via an automated candidate extraction process, at least in part, with previously annotated web page information, at least in part, comprises using at least one of the following comparison approaches: content comparison, structural comparison, context comparison, or a combination thereof.

12. The apparatus of claim 11, wherein said at least one comparison approach generates a correspondence score.

13. The apparatus of claim 10, wherein said special purpose computing platform comprises a computing platform communicatively coupled to one or more databases storing, at least in part, previously annotated web page information.

14. The apparatus of claim 10, wherein said special purpose computing platform comprises a computing platform communicatively coupled to one or more databases storing, at least in part, one or more web page information candidates.

15. The apparatus of claim 10, wherein said special purpose computing platform comprises a server; wherein said server is communicatively coupled to a network of servers.

16. The apparatus of claim 15, wherein said network of servers is compliant and/or compatible with HTTP specification.

17. A system, comprising:
a computing platform; said computing platform being operable to compare one or more web page information candidates extracted via an automated candidate extraction process, at least in part, with previously annotated web page information extracted via wrapper induction, at least in part, to determine a correspondence score.

18. The system of claim 17, wherein said computing platform is communicatively coupled to a network of computing platforms.

19. The system of claim 18, wherein said network of computing platforms comprises at least part of the Internet.

20. The system of claim 18, wherein said network of computing platforms comprises a network of servers.
